(19) United States
(12) Patent Application Publication
(10) Pub. No.: US 2009/0130519 A1
(43) Pub. Date: May 21, 2009

(54) FUEL CELL

(76) Inventors: Hiromichi Sato, Kanagawa-ken (JP); Takashi Kajiwara, Shizuoka-ken (JP); Yutaka Hotta, Shizuoka-ken (JP); Satoshi Futami, Shizuoka-ken (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 12/299,024

(22) PCT Filed: Jun. 6, 2007
(86) PCT No.: PCT/IB2007/001482

§ 371 Date: Oct. 30, 2008

(30) Foreign Application Priority Data
Jun. 19, 2006 (JP) 2006-168520

(51) Int. Cl. H01M 2/14; H01M 8/10

(52) U.S. Cl. 429/30

(57) ABSTRACT

Ribs (41a, 43a) are formed on a cathode plate (41) and an anode plate (43) of a fuel cell (10). The ribs (41a, 43a) protrude toward a contact surface of porous members (26, 27), and provided along an outer periphery of the porous members (26, 27) to surround the outer periphery of the porous members (26, 27). The rib (41a) of the cathode plate (41) and the rib (43a) of the anode plate (43) are arranged to face each other when separator (40) and the porous members (26, 27) are stacked on both sides of a power generating portion (20). The power generating portion (20), the porous members (26, 27), and the separator (40) are stacked such that a seal gasket (30) on the power generating portion (20) is partially sandwiched between the ribs (41a, 43a).

### BACKGROUND OF THE INVENTION

1. Field of the Invention

The invention relates to a fuel cell that is supplied with reaction gases and generates electric power using the supplied reaction gases.

2. Description of the Related Art

Typically, a fuel cell stacks alternately a power generating portion that has an electrolytic membrane and electrode catalyst layers, and a separator that serves as partition wall. A variety of structures of the fuel cell have been proposed.

For example, a structure of the fuel cell has been proposed in which porous members with a predetermined porosity are used as gas flow passages, and the reaction gases for power generation are supplied to the power-generating portion via the porous members. The fuel cell is provided with a seal gasket that has a lip portion (i.e., seal line) for preventing leaks of the reaction gases, on the outer periphery of the power-generating portion. Incidentally, the porous members are arranged on both sides of the power-generating portion, and the separator is arranged on the outer sides of the porous members.

Further, Japanese Patent Application Publication No. 2002-231274 (hereinafter, referred to as “JP-A-2002-231274”) describes a fuel cell in which a seal gasket and a power-generating portion are formed integrally via a frame sheet to prevent positional deviations of the seal gasket.

However, in the fuel cell with the porous members and the seal gasket described in JP-A-2002-231274, gaps (clearances) are created, for structural reasons, between the separator, the seal gasket, and the outer peripheral surfaces of the porous members. If the reaction gases are supplied to the porous members in the fuel cell above, the reaction gases flow out from the outer peripheral surfaces of the respective porous members to the gaps where the flow resistance is relatively low (such flow of the reaction gas will be hereinafter referred to as “escaping flow”). The reaction gases that flow out to the gaps where the flow resistance is relatively low are neither supplied to the power generating portion, nor used for electrochemical reactions of the fuel cell. Therefore, the utilization ratio of the reaction gases decreases, and the power generation performance also decreases.

### SUMMARY OF THE INVENTION

The invention provides a fuel cell that prevents the escaping flow of reaction gases toward the gaps.

A first aspect of the invention relates to a fuel cell comprising: a power generating portion that includes an electrolytic membrane and an electrode; separators that are arranged on both sides of the power generating portion to collect current generated by the power generating portion, and that serve as partition walls; a seal gasket that is provided on an outer peripheral portion of the power generating portion to suppress leaks of a reaction gas supplied to the fuel cell; a porous member with a predetermined porosity that is arranged on between the separator and at least one side of the power generating portion, and that serves as a flow passage through which the reaction gas is supplied to the power generating portion. The separator has a convex portion that is provided on a position corresponding to an outer periphery of the porous member, and protrudes toward the power generating portion along at least one side of the outer periphery of the porous member. Further, an embedded member is provided between the convex portion of the separator and an outer puerperal surface of the porous member.

According to the fuel cell according to the first aspect of the invention, even if the reaction gas that has been supplied to the porous member attempts to flow to a gap via the outer peripheral surface of the porous member, the reaction gas is blocked by the embedded member and the convex portion. Thus, escaping flows of the reaction gas to the gap hardly occur.

As a result, the fuel cell according to the first aspect of the invention prevents the reaction gas from flowing to the gap between the separator, the seal gasket, and the porous member. That is, escaping flows of the reaction gas to the gap do not occur. Therefore, the reaction gas supplied to the porous member may be reliably provided to the power generating portion and used for chemical reactions. As a result, the utilization rate of the reaction gas increases and the power generation performance improves accordingly.

The fuel cell described above may be such that the seal gasket is sandwiched between the convex portions of the separator when the separator is arranged on both sides of the power generating portion.

Further, the fuel cell described above may be such that a porosity of the embedded member is lower than the predetermined porosity of the porous member. In this case, because the porosity of the embedded member that fills the gap between the convex portion of the separator and the outer peripheral surface of the porous member is lower than the porosity of the porous member, the reaction gas, after supplied to the porous member, flows through the inside of the porous member where the porosity is relatively high and the pressure loss is relatively small.

The fuel cell described above may be such that the porous member has a rectangular shape, and when the main flow direction of the reaction gas that flows through the porous member is substantially parallel to two opposite sides of the rectangular porous member, the convex portion of the separator is provided along the two opposite sides.

Among the outer peripheral surfaces of the porous member, the escaping flows of the reaction gas tend to occur at the peripheral surfaces extending substantially in parallel to the flow of the reaction gas. Therefore, it is sufficient to provide the convex portion at the positions corresponding to such peripheral surfaces of the porous member.

Further, the fuel cell described above may be such that the convex portion of the separator is provided on a position where the entire outer periphery of the porous member is surrounded.

According to this structure, because the convex portion is provided so as to surround the entire outer periphery of the porous member, the escaping flows of the reaction gas may be almost perfectly prevented.

Further, the fuel cell described above may be such that the power generating portion and the seal gasket are formed integrally by inserting the outer peripheral portion of the power generating portion into a portion of the seal gasket, and both sides of the portion of the seal gasket into which the outer peripheral portion of the power generating portion is inserted is sandwiched between the convex portions of the separator when the separator is arranged on both sides of the power generating portion.

According to this structure, because the portion of the seal gasket into which the outer peripheral portion of the power generating portion is inserted is the joint between the seal gasket and the power generating portion, by sandwiching it between the convex portions of the separator, the seal gasket and the power generating portion are prevented from detaching from each other at the joint.

Further, the fuel cell described above may be such that the embedded member has adhesive characteristics for bonding the separator and the porous member. Further, the fuel cell described above may be such that that the embedded member is made of resin.

If the embedded member has such adhesiveness, the separator and the porous member may be reliably formed integrally, which prevents the porous member from rattling and deviating from its position.

Further, the fuel cell described above may be such that the separator is formed of a metal plate, and the convex portion of the separator is formed by pressing the metal plate. Further, the fuel cell described above may be such that that the separator are formed by metal plates and the convex portion of the separator is formed by performing at least one of etching and machining to the metal plate.

### BRIEF DESCRIPTION OF THE DRAWINGS

The foregoing and further objects, features and advantages of the invention will become apparent from the following description of preferred embodiments with reference to the accompanying drawings, wherein like numerals are used to represent like elements and wherein:

FIG. 1 is a view schematically showing the configuration of a fuel cell according to the first example embodiment of the invention;

FIG. 2 is a view of a cross-section according to a stacked direction of a part of the fuel cell in the first example embodiment;

FIG. 3 is a view of a cross-section according to a stacked direction of a part of the fuel cell in a related art;

FIG. 4 is a view schematically showing the configuration of a fuel cell according to the second example embodiment of the invention; and

FIG. 5 is a view of a cross-section according to a stacked direction of a part of the fuel cell in the second example embodiment.

### DETAILED DESCRIPTION OF THE PREFERRED EMBODIMENTS

Hereinafter, example embodiments of the invention will be described in detail with reference to the drawings.

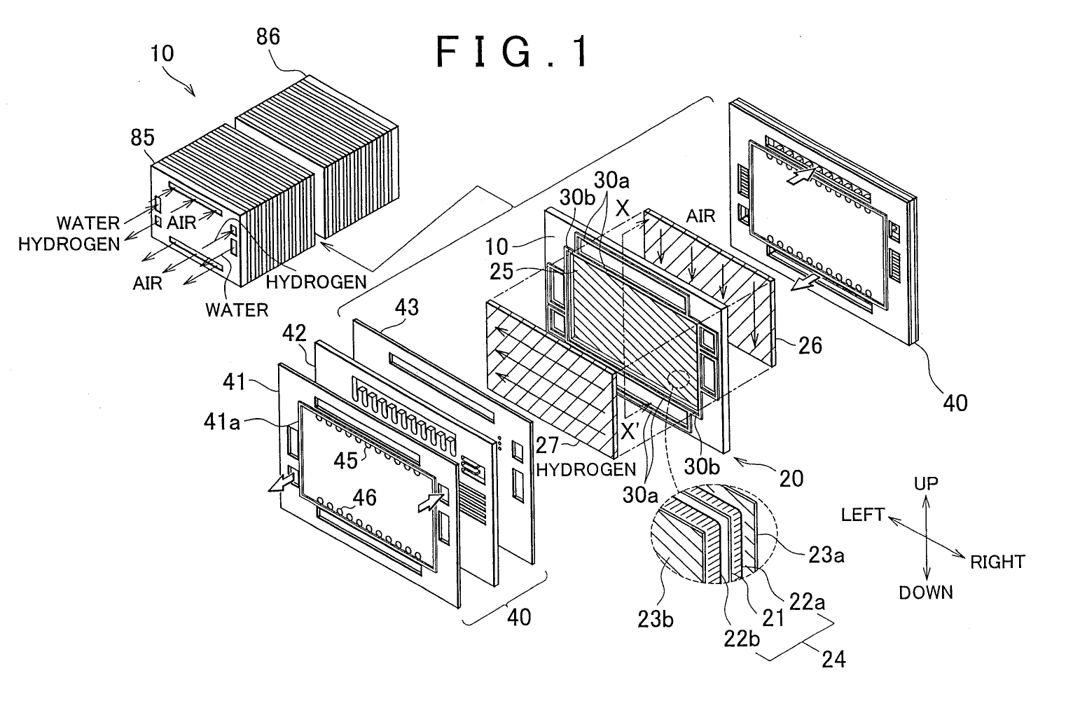

FIG. 1 is a view schematically showing the configuration of a fuel cell 10 according to the first example embodiment of the invention. The fuel cell 10 is a polymer electrolyte fuel cell that is supplied with hydrogen gas and air and generates electric power through electrochemical reaction between hydrogen and oxygen. The fuel cell 10 is mounted in a vehicle and used as the power source for producing the drive power for the vehicle.

Referring to FIG. 1, the fuel cell 10 mainly includes: a power generating portion 20 that has an electrolytic membrane 21; porous members 26, 27 that serve as reaction gas passages where air and hydrogen gas (hereinafter, referred to as “reaction gases”) flow; and a separator 40 that collects the electric power generated through the electrochemical reaction and also serves as partition walls. In the fuel cell 10, the separator 40, the porous member 27, the power generating portion 20, the porous member 26, and the separator 40 are stacked in sequence. The stacked cells are sandwiched by end plates 85, 86 from both sides, whereby the fuel cell 10 is formed.

Also, through-holes for supplying and discharging the reaction gases, for example, are formed in the end plate 85. The reaction gases are smoothly supplied from external components, such as a hydrogen tank and a compressor (not shown) to the inside of the fuel cell 10 via the through-holes.

A membrane electrode gasket assembly (hereinafter, referred to as “MEGA”) 25 and a seal gasket 30, which is arranged so as to surround the outer periphery of the MEGA 25, are formed integrally, and form the power generating portion 20. The MEGA 25 is configured by arranging gas diffusion layers 23a, 23b on both sides of a membrane electrode assembly (hereinafter, referred to as “MEA”) 24 that has a solid polymer electrolytic membrane 21.

The MEA 24 constructing the MEGA 25 has electrode catalyst layers 22a, 22b that are formed on the surfaces of the electrolytic membrane 21. The electrode catalyst layer 22a is provided on the cathode side of the MEA 24 and the electrode catalyst layer 22b is provided on the anode side of the MEA 24. The electrolytic membrane 21 may be a thin membrane, which has proton conductivity, and consists of solid polymer material with a good electric conductivity under moist and wet conditions. The electrolytic membrane 21 has a rectangular outer shape, which is smaller than the rectangular outer shape of the separator 40. The electrode catalyst layers 22a, 22b are formed on the surfaces of the electrolytic membrane 21, and contain catalyst such as platinum, which accelerates electrochemical reaction.

The gas diffusion layers 23a, 23b on the outer sides of the MEA 24, are porous members that consist of carbon with a porosity of 60-70%. For example, carbon cloths or carbon papers may be used as the gas diffusion layers 23a, 23b. The gas diffusion layers 23a, 23b of such material are attached to the MEA 24 to form the MEGA 25. The gas diffusion layer 23a is provided on the cathode side of the MEA 24 and the gas diffusion layer 23b is provided on the anode side. The gas diffusion layers 23a, 23b diffuse the supplied reaction gases in their thickness directions so that the reaction gases are supplied to the entire surfaces of the electrode catalyst layers 22a, 22b, respectively.

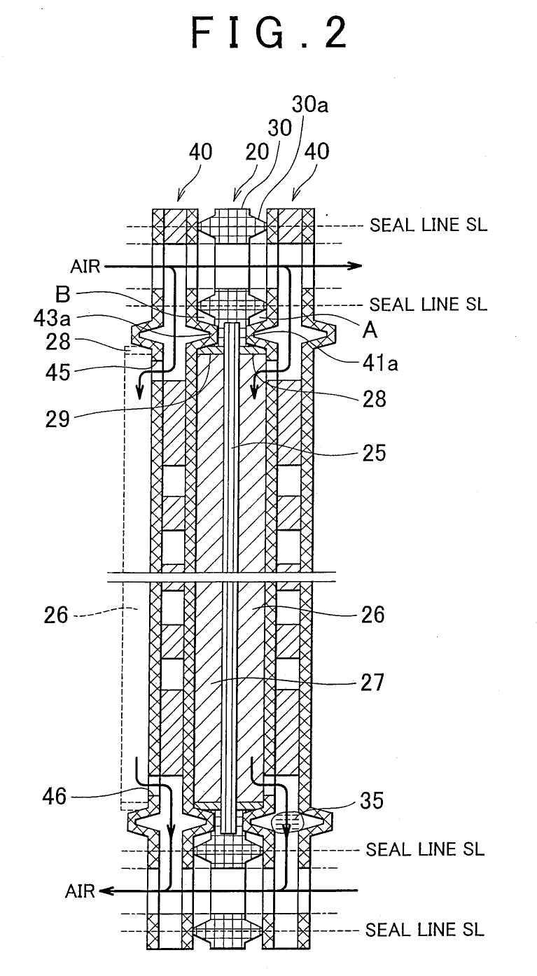

The seal gasket 30 surrounding the outer periphery of the MEGA 25, consist of an insulating resin material of elastic rubber, such as silicon rubber, butyl rubber, fluorine rubber, for example. As shown in FIG. 2, the seal gasket 30 is formed on the outer periphery of the MEGA 25 by injection molding such that the outer peripheral portion of the MEGA 25 is partially inserted into the seal gasket 30, whereby the seal gasket 30 is attached to the MEGA 25.

The seal gasket 30 is substantially formed in a rectangular shape that has the same size as the separator 40. Through-holes, which serve as manifolds of the reaction gases and cooling water, are provided along the four sides of the seal gasket 30. Because the through-holes for the manifolds communicate with the through-holes which are formed in the separator 40, the explanation about the through-holes for the manifolds will be described later with the explanation about the separator 40.

Lip portions 30a, which protrude convexly in a thickness direction of the seal gasket 30, are provided around the through-holes for the manifolds such that the respective through-holes for the manifolds is surrounded by the respective lip portions 30a. A lip portion 30b having the same shape as that of each lip portion 30a, is provided around the exposed portion of the MEGA 25 so as to surround the exposed portion of the MEGA 25. Each of the lip portions 30a may also serve as a portion of the lip portion 30b surrounding the exposed portion of the MEGA 25. The lip portions 30a, 30b abut on the separator 40 sandwiching the seal gasket 30. Thus, the lip portions 30a, 30b are compressed and deformed by receiving a prescribed clamping force in the direction where the cells are stacked in the fuel cell 10. Accordingly, as shown in FIG. 2, the lip portions 30a, 30b form seal lines SL for preventing leaks of fluids (hydrogen, air, cooling water) that flow through the respective manifolds and leaks of the reaction gasses that flow in the porous members 26, 27.

In order to prevent leaks of the fluids from the fuel cell 10, the fuel cell 10 of the first example embodiment employs the structure in which the seal gasket 30 is sandwiched in each cell, rather than the structure in which resin frames, or the like, are sandwiched between the separator and fixed by bonding. According to the first example embodiment, therefore, it is possible to reduce the number of necessary parts (e.g., resin frames) and thereby reduce the volume and weight of the fuel cell 10.

Next, the porous members 26, 27 through which the respective reaction gases flow, will be described. The porous members 26, 27 may be porous metal members with a number of pores therein, such as foamed metal and metal mesh consisting of stainless steel, titanium, and titanium-alloy. The porous members 26, 27 are smaller than the MEGA 25 and substantially have a rectangular shape. Further, the porous members 26, 27 are formed so as to have a size fitted in the seal gasket 30.

The porosity of the porous members 26, 27 is about 70-80% and thus larger than the porosity of the gas diffusion layers 23a, 23b constructing the MEGA 25. The porous members 26, 27 serve as the flow passages for supplying the reaction gases to the MEGA 25.

For example, the porous member 26 is arranged between the cathode side of the MEGA 25 (i.e., the cathode side of the MEA 24) and the separator 40. The air supplied via the separator 40 flows through the porous member 26 from “UP” to “DOWN” direction as indicated in FIG. 1. While flowing in that way, the air is supplied to the cathode side of the MEGA 25.

On the other hand, the porous member 27 is arranged between the anode side of the MEGA 25 (i.e., the anode side of the MEA 24) and the separator 40. The hydrogen gas supplied via the separator 40 flows through the porous member 27 from “RIGHT” to “LEFT” direction as indicated in FIG. 1. While flowing that way, the hydrogen gas is supplied to the anode side of the MEGA 25.

That is, because the porous members 26, 27 are provided mainly to cause the reaction gases to flow in predetermined directions as indicated in FIG. 1, the porosity of the porous members 26, 27 is relatively high so that the pressure losses of the flows of the reaction gases are suppressed and drainage of water is therefore facilitated. On the other hand, because the gas diffusion layers 23a, 23b are provided mainly to diffuse the reaction gases in their thickness directions the porosity of the gas diffusion layers 23a, 23b is relatively low.

Thus, the reaction gases through the porous members 26, 27 are supplied to the MEGA 25, and then diffused to the electrode catalyst layers 22a, 22b due to the diffusing effects of the gas diffusion layers 23a, 23b, whereby the diffused reaction gases starts the electrochemical reaction. The electrochemical reaction is an exothermic reaction and cooling water is supplied to the fuel cell 10 to operate the fuel cell 10 within a predetermined temperature range.

Next, the separator 40 collecting the electric power that is generated from the electrochemical reaction will be described. The separator 40 may be a three-layer separator consisting of three thin metal plates stacked on each other. More specifically, the separator 40 is configured by a cathode plate 41, which is placed in contact with the porous member 26 through which air flows; an anode plate 43, which is placed in contact with the porous member 27 through which hydrogen gas flows; and an middle plate 42, which is sandwiched between the cathode plate 41 and the anode plate 43 and mainly serves as a flow passage for the cooling water.

The three metal plates 41, 42, 43 consist of, for example, conductive metal such as stainless steel, titanium, and titanium-alloy.

In the three metal plates 41, 42, 43, through-holes that form a part of the respective manifolds, are provided. Specifically, a through-hole for supplying air is formed in the upper long side of the separator 40 being substantially rectangular, as viewed FIG. 1 and a through-hole for discharging air is formed in the lower long side of the separator 40 as viewed in FIG. 1. Further, a through-hole for supplying hydrogen gas is formed in the upper portion of the right short side of the separator 40 as viewed in FIG. 1, and a through-hole for discharging hydrogen gas is formed in the lower portion of the left short side of the separator 40 as viewed in FIG. 1. Likewise, a through-hole for supplying cooling water is formed in the upper portion of the left short side of the separator 40 as viewed in FIG. 1, and a through-hole for discharging the cooling water is formed in the lower portion of the right short side of the separator 40 as viewed in FIG. 1.

In addition to the manifold through-holes, multiple holes 45, 46 that serve as the inlets and outlets of the air supplied to and discharged from the porous member 26, are formed in the cathode plate 41. Likewise, in addition to the manifold through-holes, multiple holes (not shown) that serve as the inlets and outlets of the hydrogen gas supplied to and discharged from the porous member 27 are formed in the anode plate 43.

Among the manifold through-holes formed in the middle plate 42, the manifold through-holes through which air flows are formed so as to communicate with the holes 45, 46 in the cathode plate 41, and the manifold through-holes through which hydrogen gas flows are formed so as to communicate with the holes in the anode plate 43.

Further, notches are formed along the direction of a long side where the outer shape is substantially rectangular in the middle plates 42, and both ends of the notches, respectively, communicate with the manifold through-holes through which the cooling water flows.

Thus, by stacking and joining the three plates structured as described above, the flow passages where the various fluids flow, are formed in the separator 40.

In the first example embodiment, ribs 41a, 43a are formed at the cathode plate 41 and anode plate 43, which ribs 41a, 43a protrude toward the contact surface of the porous member 26, 27 and extend like a strip along the outer periphery of the porous member 26, 27 so as to surround the porous member 26, 27. The rib 43a of the anode plate 43 is obscured in FIG. 1.

The ribs 41a, 43a may be formed by, for example, pressing the thin metal plates constructing the cathode plate 41 and the anode plate 43.

FIG. 2 shows a cross-section according to a stacked direction of a part of the fuel cell 10 in the first example embodiment. Specifically, FIG. 2 shows the cross-section along the line X-X′ in FIG. 1. Referring to FIG. 2, a part of the air flowing in the manifold that is formed by stacking the separator 40 and seal gaskets 30, enters the inside of the separator 40 (i.e., the middle plate 42 in the separator 40) and then reaches the porous member 26 via the hole 45. The gas that has been used in electrochemical reaction and the air that was not used in the electrochemical reactions, flow through the porous member 26 and flow into the inside of the separator 40 after entering the manifold via the holes 46. Although the explanation about the flow of the hydrogen gas is not described herein, hydrogen gas flows in the same manner as the air.

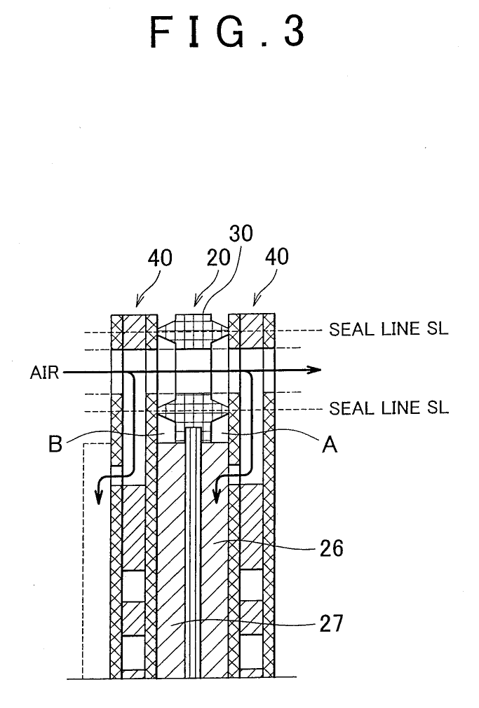

FIG. 3 shows a cross-section according to a stacked direction of a part of the fuel cell 10 in a related art. As mentioned above, in the related art, a gap A is created between the separator 40, the seal gasket 30, and the outer peripheral surface of the porous member 26, and a gap B is created between the separator 40, the seal gasket 30, and the outer peripheral surface of the porous member 27 as shown in FIG. 3. The reaction gases supplied to the porous members 26, 27 via the separator 40, tend to flow to the gaps A, B where almost no pressure loss exists, rather than flow to the inside of the porous members 26, 27 having predetermined porosities. Thus, the reaction gases flow from the outer peripheral surfaces of the porous members 26, 27 into the gaps A, B, respectively. That is, escaping flows of the reaction gases to the gaps A, B occur.

On the other hand, according to the first example embodiment as described above, because the ribs 41a, 43a are formed on the surfaces of the cathode plate 41 and the anode plate 43 toward the contact surface of the porous members 26, 27, the reaction gases may be prevented from flowing into the gaps A, B.

Hereinafter, the structure around the ribs 41a, 43a in the first example embodiment will be described. In the first example embodiment, for example, prior to stacking the porous members 26, 27 and the separator 40 on both sides of the power generating portion 20, the porous member 26 is put in the flat area where is surrounded by the rib 41a of the cathode plate 41, as shown in FIG. 2. Then, the gap between the rib 41a and the porous member 26 is filled by a wax material 28 so that the rib 41a and the porous member 26 are bonded to each other by the wax material 28. Likewise, the porous member 27 is put in the flat area where is surrounded by the rib 43a of the anode plate 43. Then, the gap between the rib 43a and the porous member 27 is filled by a wax material 29 so that the rib 43a and the porous member 27 are bonded to each other by the wax material 29. Then, when the porous members 26, 27 and the separator 40 are stacked on both sides of the power generating portion 20, the rib 41a of the cathode plate 41 and the rib 43a of the anode plate 43 are arranged to face each other. That is, the power-generating portion 20, the porous members 26, 27, and the separator 40 are stacked such that the seal gasket 30 in the power generating portion 20, is partially sandwiched between the rib 41a and the rib 43a.

Accordingly, in the first example embodiment as shown in FIG. 2, the ribs 41a, 43a of the separator 40 and the wax materials 28, 29 occupy the spaces where the gaps A, B are created in the related-art shown in FIG. 3. Thus, the most parts of the gaps A, B may be filled by the ribs 41a, 43a and the wax materials 28, 29, respectively.

In the first example embodiment, the MEGA 25 may be regarded as a power generating portion, the ribs 41a, 43a may be regarded as a convex portion, and the wax materials 28, 29 may be regarded as a embedded member in the invention, respectively.

The porosity of the wax materials 28, 29 and the porosity of the ribs 41a, 43a, are lower than the porosity of the porous members 26, 27, respectively. Therefore, as described above, the reaction gases that are supplied from the holes 45 of the separator 40 for the air and the holes of the separator 40 (not shown) for the hydrogen gas, flow into the inside of porous members 26, 27 where the porosity is relatively high and the pressure loss is relatively small. That is, even if the reaction gases that is supplied to the porous members 26, 27 attempt to flow to the gaps A, B via the outer peripheral surfaces of the porous members 26, 27, the reaction gases are blocked first by the wax materials 28, 29 and then by the ribs 41a, 43a. Therefore, it is almost impossible for the reaction gasses to flow out to the gaps A, B. That is, escaping flows of the reaction gases hardly occur. In particular, because the seal gasket 30 is partially sandwiched between the rib 41a, 43a, the seal gasket 30 is compressed between the tips of the ribs 41a, 43a, the outflow of the reaction gases to the gaps A, B may be prevented almost perfectly.

As described above, according to the fuel cell 10 in the first example embodiment, it is possible to prevent the occurrence of outflows, i.e., escaping flows of the reaction gases to the gaps A, B where is surrounded by the separator 40, the seal gasket 30, and the porous members 26, 27. Therefore, the reaction gases supplied to the porous members 26, 27, may be reliably provided to the MEGA 25, and be used for the electrochemical reaction. As a result, the utilization ratio of the reaction gases may increase and the power generation performance may also improve.

According to the fuel cell 10 of the first example embodiment, the gaps between the ribs 41a, 43a and the porous members 26, 27 are filled by the wax materials 28, 29, respectively, and further the ribs 41a, 43a and the porous members 26, 27 are bonded to each other by the wax materials 28, 29. Therefore, even if there are dimensional errors of the porous members 26, 27, the porous members 26, 27 do not rattle nor deviate from their positions.

According to the fuel cell 10 of the first example embodiment, the ribs 41a, 43a on the cathode plate 41 and the anode plate 43, respectively, are formed so as to surround the outer periphery of the porous members 26, 27. Therefore, when putting the porous members 26, 27 on the cathode plate 41 and the anode plate 43, respectively, the porous members 26, 27 may be easily set in their positions by the ribs 41a, 43a.

According to the fuel cell 10 of the first example embodiment, the seal gasket 30 of the power generating portion 20 is partially sandwiched between the ribs 41a, 43a on the cathode plate 41 and the anode plate 43. However, as shown in FIG. 2, the portion of the power-generating portion 20 sandwiched between the ribs 41a, 43a, is the portion at which the outer peripheral portion of the MEGA 25 is inserted into the seal gasket 30. That is, the ribs 41a, 43a sandwich the bonded portion between the seal gasket 30 and the MEGA 25. On the other hand, because the seal gasket 30 and the MEGA 25 are formed integrally, when a deterioration due to the use environment and the use conditions occurs, the bonded portion between the seal gasket 30 and the MEGA 25 may detach from each other, which may cause cross leaks of the reaction gases, that is, hydrogen gas and air. However, according to the fuel cell 10 of the first example embodiment, because the bonded portion between the seal gasket 30 and the MEGA 25 is sandwiched between the ribs 41a, 43a, the seal gasket 30 and the MEGA 25 do not detach from each other at the bonded portion, and thus cross leaks of the reaction gases may be avoided.

According to the fuel cell 10 in the first example embodiment, further, the ribs 41a, 43a, as described above, are formed on the cathode plate 41 and the anode plate 43 by pressing, for example. Therefore, each of the ribs 41a, 43a appears like a groove as shown in FIG. 2. Therefore, even when water 35, which has been produced in the cathode side by chemical reactions, stops at the ribs 41a, 43a after entering the inside of the separator 40 via the holes 46 together with air as indicated in FIG. 2, the air, which is the reaction gas, passes through the side of the water 35 and flows along the groove-shaped ribs 41a, 43a. As such, the air flow is not blocked by the water 35.

According to the first example embodiment, further, the heights of the rib 41a of the cathode plate 41 and the rib 43a of the anode plate 43 may be set in consideration of the thickness of each of the porous members 26, 27 and the thickness of the portion of the seal gasket 30 to be sandwiched between the ribs 41a and 43a. For example, the heights of the ribs 41a, 43a may be set to a value which enables the seal gasket 30 to be compressed between the tips of the ribs 41a, 43a when they are stacked and which reduces the contact resistance between the porous member 26 and the separator 40 and the contact resistance between the porous member 27 and the separator 40.

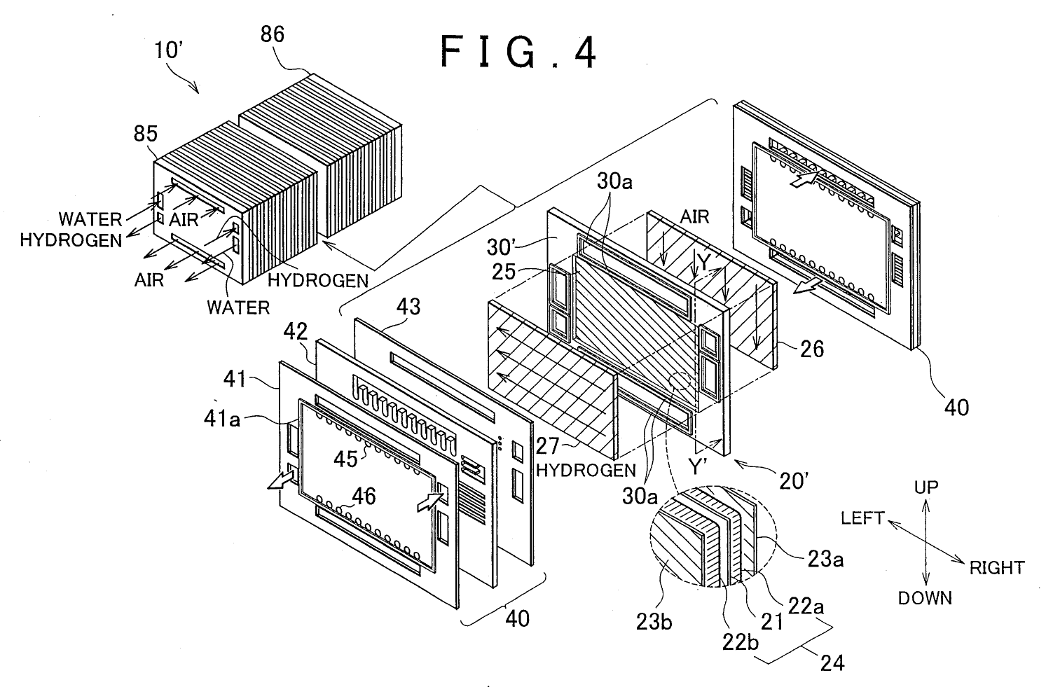

FIG. 4 is a view schematically showing the configuration of a part of a fuel cell 10′ according to the second example embodiment of the invention. The fuel cell 10′ of the second example embodiment has basically the same structure as that of the fuel cell 10 of the first example embodiment. Therefore, the components and elements that are the same as those in the fuel cell 10 of the first example embodiment will be denoted by the same numerals and their descriptions will be omitted.

Referring to FIG. 4, like the fuel cell 10 of the first example embodiment, the fuel cell 10′ of the second example embodiment includes: a power generating portion 20′, porous members 26, 27, and separator 40. In fuel cell 10′, the separator 40, the porous member 27, the power-generating portion 20′, the porous member 26, and the separator 40 are stacked in sequence or vice-versa. The stacked cells are sandwiched by end plates 85, 86 from both sides, whereby the fuel cell 10′ is formed.

The structural difference of the fuel cell 10′ of the second example embodiment from the fuel cell 10 of the first example embodiment lies in the structure of the seal gasket 30′ of the power generating portion 20′. Specifically, while the lip portions 30a surrounding the respective manifold through-holes and the lip portion 30b surrounding the exposed portion of the MEGA 25 are formed in the seal gasket 30 in the first example embodiment, in the second example embodiment, the lip portion 30b is removed and instead the ribs 41a, 43a of the separator 40 are formed so as to play the role of the lip portion 30b that surrounds the exposed portion of the MEGA 25, (i.e., the role of preventing leaks of the reaction gases flowing through the porous members 26, 27).

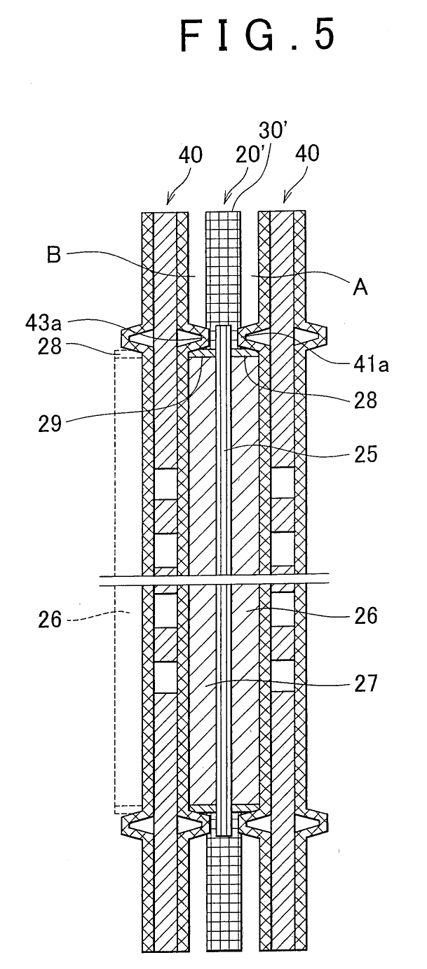

FIG. 5 shows a cross section according to a stacked direction of a part of the fuel cell 10′ in the second example embodiment. That is, FIG. 5 is the cross-section taken along the line Y-Y′ in FIG. 4, i.e., the cross section of the region in which none of the manifold through-holes is present.

Hereinafter, the structure around the ribs 41a, 43a in the second example embodiment will be described. In the second example embodiment, the porous members 26, 27 and the separator 40 are stacked on the power generating portion 20′ in the same manner as in the first example embodiment. That is, the porous members 26, 27 are put in the flat area surrounded by the ribs 41a, 43a on the cathode plate 41 and the anode plate 43. Then, the gaps between the rib 41a, 43a and the porous members 26, 27 are filled by the wax materials 28, 29 so that the ribs 41a, 43a and the porous members 26, 28 are bonded by the wax materials 28, 29. Then, the rib 41a of the cathode plate 41 and the rib 43a of the anode plate 43 are arranged to face each other. The seal gasket 30 of the power generating portion 20′ is partially sandwiched between the rib 41a and the rib 43a.

As a result, as shown in FIG. 5, the ribs 41a, 43a of the separator 40 and the wax materials 28, 29 occupy the spaces where the gaps A, B are created in the related-art shown in FIG. 3. Thus, the most parts of the gaps A, B are filled by the ribs 41a, 43a and the wax materials 28, 29, respectively.

Thus, when the reaction gases are supplied to the porous members 26, 27 via the holes 45 for air and the holes (not shown) for hydrogen gas in each separator 40, the supplied reaction gases flow through the inside of the porous members 26, 27 where the porosity is higher and the pressure loss is smaller than the wax materials 28, 29. That is, even if the reaction gases that are supplied to the porous members 26, 27 attempt to flow to the gaps A, B via the outer peripheral surfaces of the porous members 26, 27, the reaction gases are blocked first by the wax materials 28, 29 and then blocked by the ribs 41a, 43a. Therefore, escaping flows of the reaction gasses to the gaps A, B hardly occur.

Further, the seal gasket 30′ is partially sandwiched between the rib 41a and the rib 43a and compressed by the tips of the ribs 41a, 43a. Therefore, the outflow of the reaction gases to the gaps A, B may be perfectly prevented. Thus, the ribs 41a, 43b serve, instead of the lip portion 30b of the seal gasket 30′ that surrounds the exposed portion of the MEGA 25, to prevent leaks of the reaction gas flowing through the porous members 26, 27.

As mentioned above, according to the fuel cell 10′ of the second example embodiment, it is possible to prevent the occurrence of escaping flows of the reaction gases to the gaps A, B where are surrounded by the separator 40, the seal gasket 30′, the porous members 26, 27. Therefore, the reaction gases that have been supplied to the porous members 26, 27 are reliably provided to the MEGA 25 and used for the electrochemical reaction. Consequently, the utilization ratio of the reaction gases increase and the power generation performance improves.

According to the fuel cell 10′ of the second example embodiment, because the ribs 41a, 43a of the separator 40 play the role of the lip portion 30b of the seal gasket, the lip portion 30b of the seal gasket may be omitted. Accordingly, the structure of the seal gasket 30′ may be simplified.

Also, according to the fuel cell 10′ of the second example embodiment, the other advantages that have been described with the first example embodiment may also be obtained.

It is to be understood that the invention is not limited to the foregoing example embodiments, but may be embodied in various other forms and structures within the spirit of the invention.

In the first example embodiment as shown in FIG. 1, air flows through the porous member 26 from the upper side to the lower side and hydrogen gas flows through the porous member 27 from the right side to the left side. That is, air and hydrogen gas flow in the directions perpendicular to each other. Thus, the rib 41a of the cathode plate 41 and the rib 43a of the anode plate 43 are formed so as to surround the porous members 26, 27, respectively. However, the invention is not limited to such structures. For example, in a structure where air and hydrogen gas flow in parallel, two sides of each of the porous members 26, 27, which are both substantially rectangular, extend substantially in parallel to the flows of air and hydrogen gas. In such a case, the ribs 41a, 43a may be formed only at the portions along these two sides of each of the porous members 26, 27. In other words, the portions of the ribs 41a, 43a that are formed along the other two sides of each of the porous members 26, 27 (the sides extending substantially perpendicular to the flows of air and hydrogen gas) may be removed.

That is, among the outer peripheral surfaces of the porous members 26, 27, the aforementioned escaping flows of the reaction gases tend to occur at the peripheral surfaces of each of the porous members 26, 27 that extend substantially in parallel to the flows of the reaction gases. Therefore, it is sufficient to provide the ribs 41a, 43a at the positions corresponding to such peripheral surfaces of the porous members 26, 27.

In the first and second example embodiments, the ribs 41a, 43a are formed by pressing the thin metal plates forming the cathode plate 41, 43. However, the invention is not limited to this. For example, the ribs 41a, 43a may be formed by removing unnecessary parts of the metal plates by means of etching or machining. Alternatively, the ribs 41a, 43a may be formed by attaching strip-shaped parts each having a convex cross-section to the metal plates.

In the first and second example embodiments, the separator 40 are a three-layer separator which is formed by staking three metal plates on top of each other, and the reaction gases are supplied from the holes to the porous members 26, 27 via the manifold and the inside of the separator 40 (the area of the middle plate 42). Also, the exhaust gases are discharged from the porous members 26, 27 into the manifold via the other holes and the inside of the separator 40. However, the invention is not limited to such configurations.

For example, the separator 40 may be a two-layer separator or a single-layer separator, rather than a three-layer separator. In the case where each of the separator 40 is a single-layer separator, the ribs 41a, 43a are formed in methods other than pressing.

Also, regarding the passages of the reaction gases, the reaction gas may be supplied from the manifold to the inside of the porous member through between the separator and the seal gasket and then through the outer peripheral surfaces of the porous member, and the exhaust gas may be discharged from the inside of the porous member to the manifold through the outer peripheral surfaces of the porous member and then through between the separator and the seal gasket. In this case, preferably, the ribs 41a, 43a are not formed at the portion of the cathode plate 41 through which the flow passage for supplying the reaction gas from the manifold to the porous member extends and anode plate 43 through which the flow passage for discharging the exhaust gas from the porous member to the manifold extends. In this case, the ribs 41a, 43a may be not formed or formed in a restricted height at portions corresponding to the passages where the reaction gases flow from the manifold to the porous member and vise versa.

In the first and second example embodiments, the gaps between the ribs 41a, 43a and the porous members 26, 27 are filled by the wax materials 28, 29, and the ribs 41a, 43a and the porous members 26, 27 are bonded by the wax materials 28, 29. However, adhesive resins may be used instead of the wax materials. For example, thermosetting resins, such as epoxy resin, phenol, polystyrene, and urea resin may be used instead of the wax materials. Furthermore, thermoplastic resins, such as PET (polyethylene terephthalate), PS (polystyrene), PEEK (polyether ether ketone), and PES (polyether sulfone) may be used instead of the wax materials.

While the invention has been described with reference to example embodiments thereof, it is to be understood that the invention is not limited to the described embodiments or constructions. To the contrary, the invention is intended to cover various modifications and equivalent arrangements. In addition, while the various elements of the example embodiments are shown in various combinations and configurations, other combinations and configurations, including more, less or only a single element, are also within the spirit and scope of the invention.

1. A fuel cell comprising:
a power generating portion that includes an electrolytic membrane and an electrode;
separators that are arranged on both sides of the power generating portion to collect current generated by the power generating portion, and that serve as partition walls;
a seal gasket that is provided on an outer peripheral portion of the power generating portion to suppress leaks of a reaction gas supplied to the fuel cell;
a porous member with a predetermined porosity that is arranged on between the separator and at least one side of the power generating portion, and that serves as a flow passage through which the reaction gas is supplied to the power generating portion, wherein the separator has a convex portion that is provided on a position corresponding to an outer periphery of the porous member, and protrudes toward the power generating portion along at least one side of the outer periphery of the porous member; and
an embedded member that is provided between the convex portion of the separator and an outer puerperal surface of the porous member.

2. The fuel cell according to claim 1, wherein the seal gasket is sandwiched between the convex portions of the separator when the separator is arranged on both sides of the power generating portion.

3. The fuel cell according to claim 1, wherein a porosity of the embedded member is lower than the predetermined porosity of the porous member.

4. The fuel cell according to claim 1, wherein the porous member has a rectangular shape, and
when the main flow direction of the reaction gas that flows through the porous member is substantially parallel to two opposite sides of the rectangular porous member, the convex portion of the separator is provided along the two opposite sides.

5. The fuel cell according to claim 1, wherein the convex portion of the separator is provided on a position where the entire outer periphery of the porous member is surrounded.

6. The fuel cell according to claim 1, wherein the power generating portion and the seal gasket are formed integrally by inserting the outer peripheral portion of the power generating portion into a portion of the seal gasket, and
both sides of the portion of the seal gasket into which the outer peripheral portion of the power generating portion is inserted is sandwiched between the convex portions of the separator when the separator is arranged on both sides of the power generating portion.

7. The fuel cell according to claim 1, wherein the embedded member has adhesive characteristics for bonding the separator and the porous member.

8. The fuel cell according to claim 1, wherein the separator are formed of a metal plate, and the convex portion of the separator is formed by pressing the metal plate.

9. The fuel cell according to claim 1, wherein the separator is formed of a metal plate, and the convex portion of the separator is formed by performing at least one of etching and machining to the metal plate.
